(19) United States
(12) Patent Application Publication
(10) Pub. No.: US 2013/0280590 A1
(43) Pub. Date: Oct. 24, 2013

(54) ELECTROCHEMICAL ENERGY STORAGE DEVICE WITH FLAT CELLS AND SPACING ELEMENTS

(71) Applicants: Tim Schaefer, Harztor (DE); Jens Meintschel, Bernsdorf (DE)

(72) Inventors: Tim Schaefer, Harztor (DE); Jens Meintschel, Bernsdorf (DE)

(73) Assignee: Li-Tec Battery GmbH, Kamenz (DE)

(21) Appl. No.: 13/823,933

(22) PCT Filed: Sep. 7, 2011
(86) PCT No.: PCT/EP2011/004509

§ 371 Date: Jul. 3, 2013

(30) Foreign Application Priority Data
Sep. 16, 2010 (DE) 102010045700.0

(51) Int. Cl. H01M 2/10; H01G 9/004

(52) U.S. Cl. CPC H01M 2/1061; H01G 9/004
USPC 429/159; 361/434

(57) ABSTRACT

An electrochemical energy storage device comprises a plurality of flat storage cells (2) each having a first current conductor (18a) and a second current conductor (18b) on a narrow side of the storage cell (2); a plurality of spacing elements (4) each being arranged between two storage cells (2) for maintaining a predetermined distance between the storage cells (2); and a clamping means (10) for clamping the storage cells (2) and spacing elements (4) together to form a stack. The spacing elements (4) each have a first pressure surface (22a) and a second pressure surface (22b) on their two sides facing a storage cell (2). Thereby, in each case, the one current conductor (18a, 18b) of the storage cells (2) is clamped between the first pressure surface (22a) of two spacing elements (4) by means of force fit by the clamping means (10), and the other current conductor (18b, 18a) of the storage cells (2) is clamped between the second pressure surfaces (22b) of two spacing elements (4) by means of force fit by the clamping means (10). In the region of the first pressure surfaces (22a) and/or in the region of the second pressure surfaces (22b) of a spacing element (4), in each case a contact element (26) is provided for making an electrically conductive connection between the first or second pressure surfaces (22a, 22b) of a spacing element (4), and finally, the spacing elements (4) and/or the contact elements (26) are formed such that the compressions between the first pressure surfaces (22a) and between the second pressure surfaces (22b) are conformed to one another.

The present invention relates to an electrochemical energy storage device with flat cells and spacing elements.

The construction of an electrical energy storage device from a plurality of electrochemical storage cells, which are assembled into a block by means of a clamping means, is known in the art. Storage cells of this kind include, for example, pouch or coffee bag cells in the form of storage cells of a flat and rectangular construction for electrical energy (battery cells, storage battery cells, capacitors, . . . ), the electrochemically active part of which is surrounded by a film-like packaging, through which electrical connections in sheet metal form, so-called (current) conductors, protrude. The electrical series or parallel connection of the cells is achieved by conductive contact elements, which make the electrical connection between the corresponding current conductors of adjacent cells. It is common here for the cells to be arranged in a stack, loosely held in a frame or pressed together by a bracket or the like and for the terminals or current conductors exposed at the top to be connected using suitable means. An electrochemical energy storage device of this kind is described in WO 2010/081704 A2, for example.

It is an object of the present invention to provide an improved electrochemical energy storage device in which a plurality of flat storage cells with current conductors disposed on one narrow side is arranged, securely fixed and reliably interconnected in a stable block.

This object achieved by an electrochemical energy storage device having the features of the independent claim 1.

Preferred constructions and further developments of the invention are the subject-matter of the dependent claims.

The electrochemical energy storage device of the invention comprises a plurality of flat storage cells, each having a first current conductor and a second current conductor on one narrow side of the storage cell; a plurality of spacing elements, each being arranged between two storage cells to maintain a predetermined distance between the storage cells; and a clamping means for clamping the storage cells and the spacing elements together to form a stack. The spacing elements each have on their two sides facing a storage cell a first pressure surface and a second pressure surface. Thereby, in each case, the one current conductor of the storage cells is clamped between the first pressure surfaces of two spacing elements by means of force fit by the clamping means and the other current conductor of the storage cells is clamped between the second pressure surfaces of two spacing elements by means of force fit by the clamping means. In addition, in the region of the first pressure surfaces and/or in the region of the second pressure surfaces of a spacing element, in each case a contact element is provided for making an electrically conductive connection between the first or second pressure surfaces of a spacing element. Moreover, the spacing elements and/or the contact elements are designed in such a way that the compressions between the first pressure surfaces and between the second pressure surfaces are conformed to one another.

Since the current conductors of the storage cells are each clamped between the first or second pressure surfaces of two spacing elements by means of force fit by the clamping means, a predetermined distance between adjacent storage cells of the cell block is retained, said distance being capable of being set in such a way that no clamping force is applied to an electrochemically active part of the storage cells. This has advantages in respect of the functional reliability, durability and temperature management of the storage cells.

Since contact elements for the electrical connection of the first and/or second pressure surfaces are additionally provided in the region of the pressure surfaces, the current conductors of adjacent cells can be electrically connected in the desired manner (i.e. connection in series or in parallel) without additional connectors. The contact elements may be preassembled with the spacing elements or create a spacing element themselves; this makes for easier assembly. Since, in addition, the contact elements are also clamped by means of the clamping means as part of the spacing elements and are therefore kept stationary, they cannot be lost during operation of the device or no further securing measures are required to prevent this from happening.

Since the compressions between the first pressure surfaces and between the second pressure surfaces are substantially conformed to one another, the forces applied via the first and second pressure surfaces to the current conductors of the storage cells can be uniformly absorbed and distributed and a one-sided yielding of the spacing elements and distortion of the entire stack structure are avoided during clamping by the clamping means.

An “electrochemical energy storage device” in the present case should be understood to refer to any kind of energy store from which electrical energy can be taken out, wherein an electrochemical reaction takes place within the energy store. The term covers energy stores of all kinds, particularly primary batteries and secondary batteries. The plurality of electrochemical cells of the energy storage device may be connected in parallel to store a greater amount of charge or connected in series to achieve a desired operating voltage or create a combined parallel and series connection.

An “electrochemical cell” or “electrochemical energy storage cell” in the present case should be understood to refer to a device which is used to deliver electrical energy, the energy being stored in chemical form. In the case of rechargeable secondary batteries, the cell is also configured to receive electrical energy, convert it into chemical energy and store it.

A “current conductor” in the context of the present invention should be understood to refer to an electrically conductive structural element of an electrochemical storage cell, which is used to transport electrical energy into the storage cell or out of the storage cell. Electrochemical storage cells usually have two kinds of current conductors, each of which are connected in an electrically conductive manner to one of the two electrodes or electrode groups—anodes or cathodes—inside the storage cell. In other words, each electrode in the electrode stack of the storage cell has its own current conductor or electrodes of equal polarity in the electrode stack are connected to a common current conductor. Accordingly, each storage cell has a first current conductor (e.g. for the positive terminal connection) and a second current conductor (e.g. for the negative terminal connection). The form of the current conductors is adapted to the form of the storage cell and of its electrode stack, respectively.

The spacing elements preferably each have a third pressure surface in addition on their two sides facing a storage cell, in the region of a narrow side, on which the current conductors of the storage cell are not disposed. The spacing elements and/or the contact elements are then configured in such a manner that the compressions between the first pressure surfaces, between the second pressure surfaces and between the third pressure surfaces are conformed to one another.

The third pressure surface of the spacing elements is preferably provided in the region of a narrow side of the spacing elements lying opposite the first and second pressure surfaces. Alternatively, the third pressure surface may also be provided in the region of a narrow side of the spacing elements, which is adjacent to each narrow side, on which the first and second pressure surfaces are provided. In addition, it is possible for third pressure surfaces to be provided in a plurality of regions of the plurality of aforementioned narrow sides of the spacing elements.

With the help of the third pressure surfaces of the spacing elements, the storage cells of the stack may be advantageously held at a further point. The third pressure surfaces of two adjacent spacing elements preferably include a section of a casing of the storage cell or a sealing seam of such a casing between them.

In a preferred configuration of the invention, the storage cells of the stack are connected in series. For this purpose, the storage cells are preferably stacked behind one another, such that the first current conductors and the second current conductors of the storage cells are each arranged alternately behind one another. Moreover, in the region of the one pressure surface of a spacing element in each case, a contact element is provided for making an electrically conductive connection between these one pressure surfaces of the spacing element and in the region of the other pressure surfaces of a spacing element in each case, an insulating structure is provided for forming electrical insulation between these other pressure surfaces of the spacing element.

In a further preferred configuration of the invention, the storage cells of the stack are connected in parallel. For this purpose, the storage cells are preferably stacked behind one another, such that the first current conductors of all storage cells are arranged behind one another and the second current conductors of all storage cells are arranged behind one another. Moreover, in the region of the first pressure surfaces and in the region of the second pressure surfaces of a spacing element in each case, a contact element is provided to create an electrically conductive connection between the first and the second pressure surfaces of a spacing element.

The clamping means preferably comprises a plurality of tie rods, preferably two or four, said tie rods extending through bores in the first or second current conductors. By means of a configuration of this kind, the clamping force is concentrated at the point where the gripping force is intended to act, namely on the current conductors.

In order to avoid short-circuits, the tie rods are preferably encased in an electrically insulating material or surrounded by a continuous insulating sleeve.

The contact elements are preferably made of an electrically conductive material and accommodated in the spacing elements.

The insulating structures preferably each have at least one supporting element made of an electrically insulating material (preferably a glass or ceramic material), which is accommodated in the respective spacing element.

By means of the contact elements or supporting elements configured and arranged in this manner, material usage for the special functions of contacting and support can be minimized and the total weight can also be reduced by saving on the customarily heavier material used for contacting.

It is particularly preferable for the end face of the supporting elements to be at least as large as, particularly larger than, the end face of the contact elements. This means that the compression forces are reliably absorbed and damage to the spacing elements is avoided.

The contact elements and the supporting elements are preferably substantially configured in sleeve form and accommodated in corresponding recesses in the spacing elements. The clamping means, i.e. preferably the tie rods, then preferably extend through these sleeve-shaped contact or supporting elements.

In an alternative preferred configuration, the contact and/or supporting elements are configured in strip form and accommodated in corresponding recesses in the spacing elements and provided with clearance holes in which the tie rods run. In a further preferred alternative, the spacing elements are entirely configured as a supporting element or as a contact element. In all cases, a particularly space-saving configuration is achieved, in which contacting and clamping is realized by concentric structural elements. In addition, the clamping force of the clamping means is concentrated on the contact elements and a particularly reliable electrical contact is therefore achieved.

Each spacing element is preferably configured as a substantially four-sided frame. Particularly preferable in this case are two parallel frame sides, each configured with pressure bars having first/second or third pressure surfaces lying opposite on the face side. In this way, each storage cell is arranged in the stack direction between two frames and the distance of the spacing elements transversely to the stack direction is fixed by the frame sides connecting the pressure bars. The stack of storage cells and spacing elements is therefore stabilized right at the assembly stage.

Particularly preferably, the stack has two conductive, preferably frame-shaped, pressure end pieces, which lie on the first or last spacing element in the stack direction, are clamped with the stack by means of the clamping means and are electrically connected by means of the contact elements in the first or last spacing element to a current conductor of the first or last storage cell. In this way, the end pieces act as terminals of the electrochemical energy storage device from which the entire voltage can be tapped.

The invention is particularly advantageously useable in lithium-ion accumulator batteries.

The above and further features, functions and advantages of the present invention are more clearly evident from the following description, which has been written with reference to the attached drawings. These show schematically for the most part and not always to scale:

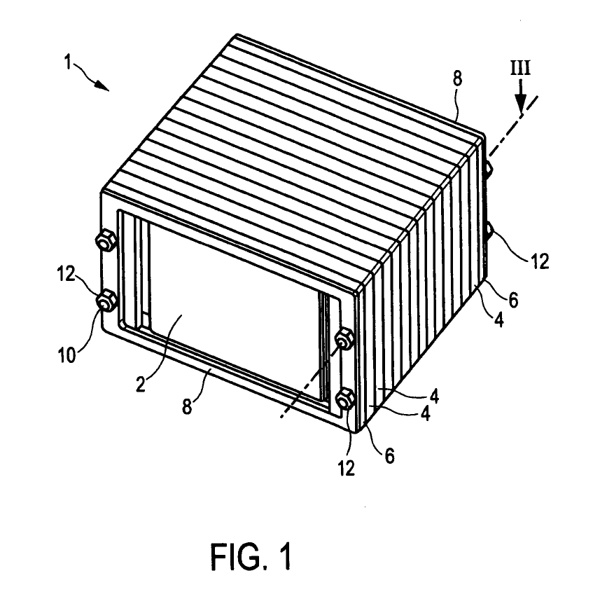

FIG. 1 a perspective representation of a cell block according to the invention in the assembled state;

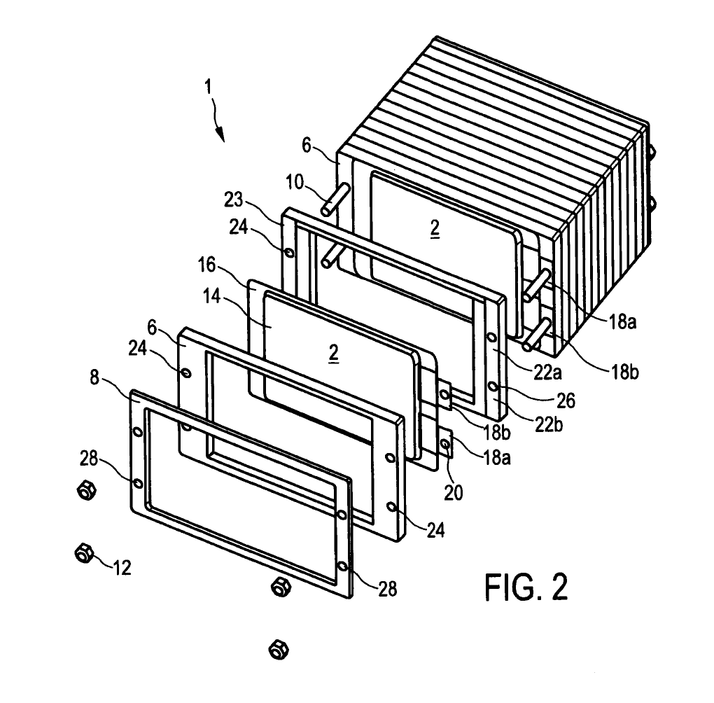

FIG. 2 a perspective exploded view of the cell block of FIG. 1 according to a first exemplary embodiment in a partially assembled state;

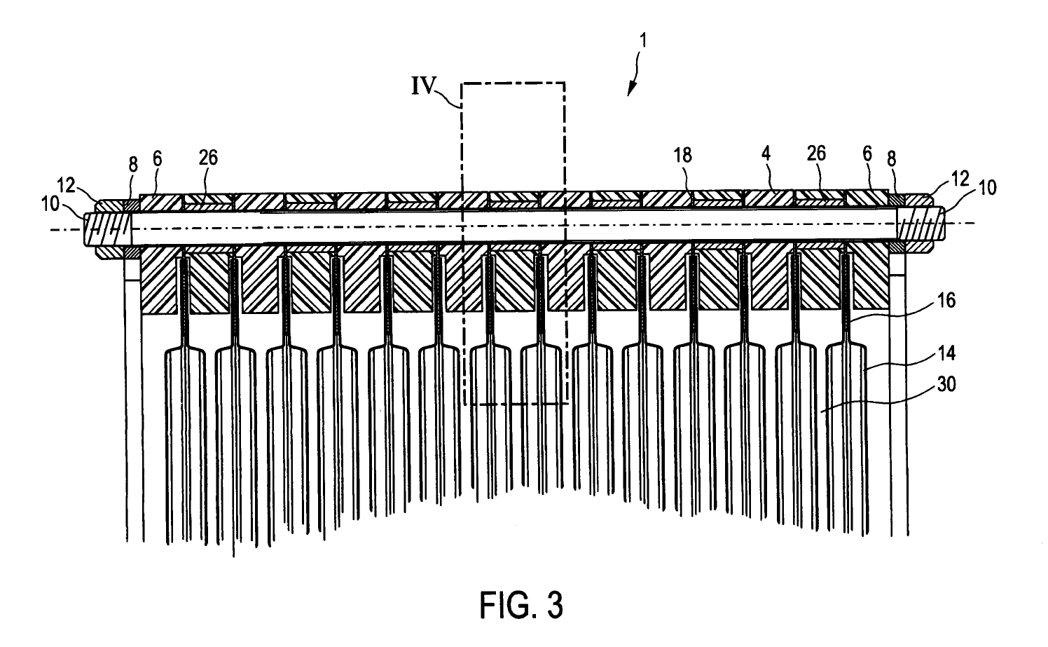

FIG. 3 a partial plan view of the cell block of FIG. 2 as a horizontal longitudinal section;

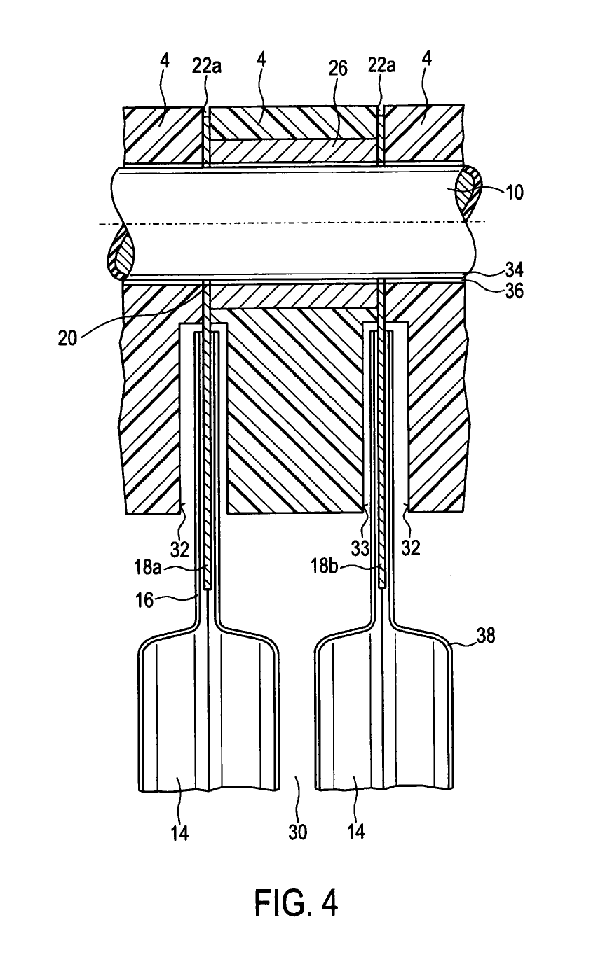

FIG. 4 an enlarged view of the detail IV in FIG. 3;

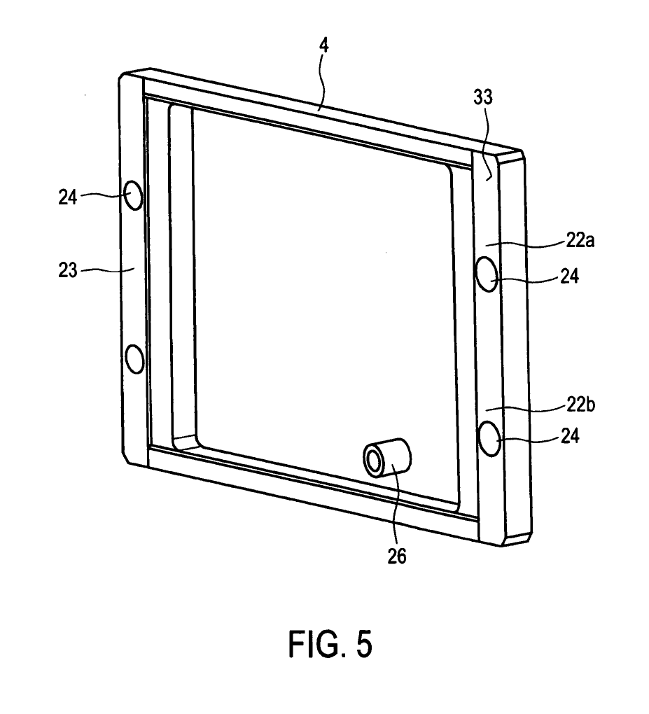

FIG. 5 a frame of the cell block of FIG. 2 with contact elements in an exploded view;

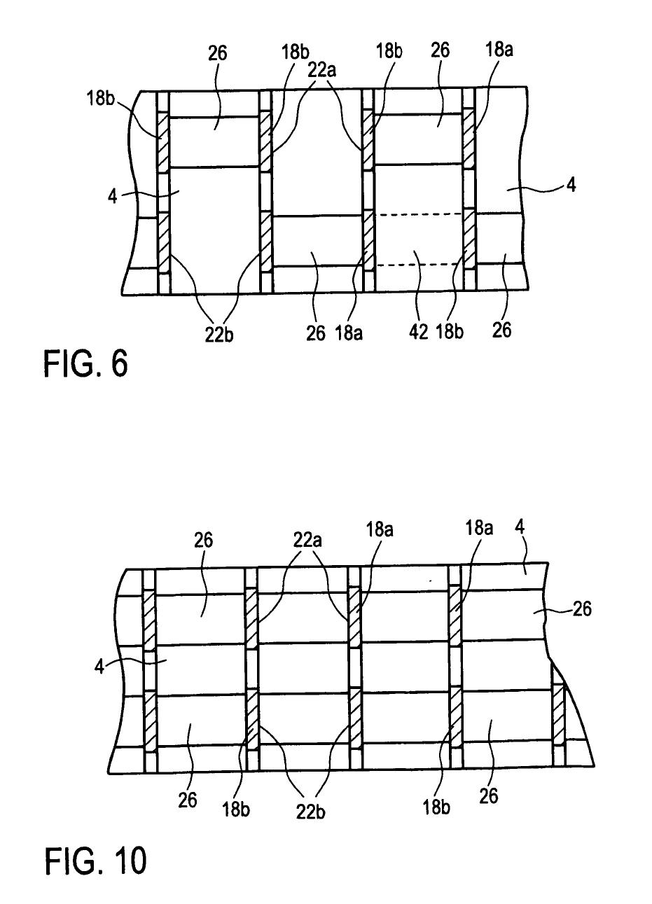

FIG. 6 a schematic plan view of a narrow side of the cell block of FIG. 2 to illustrate the series connection of the storage cells;

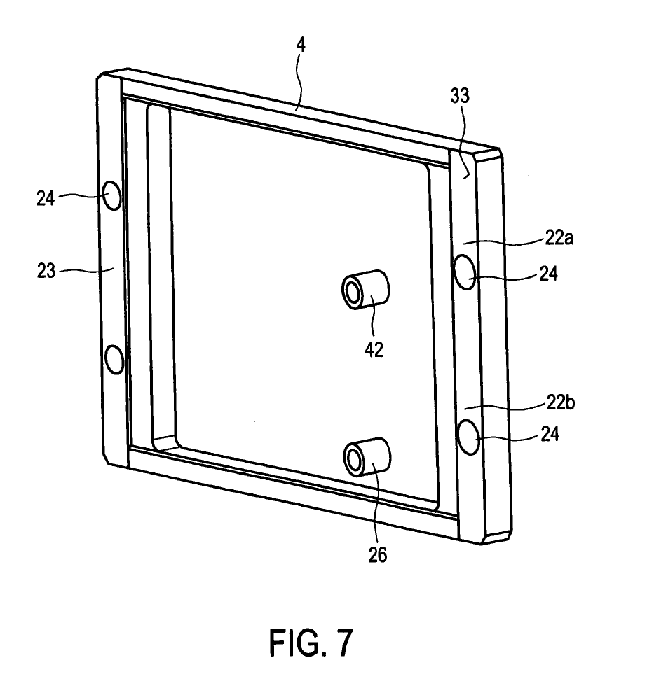

FIG. 7 a frame of a cell block according to a second exemplary embodiment in a view corresponding to FIG. 5;

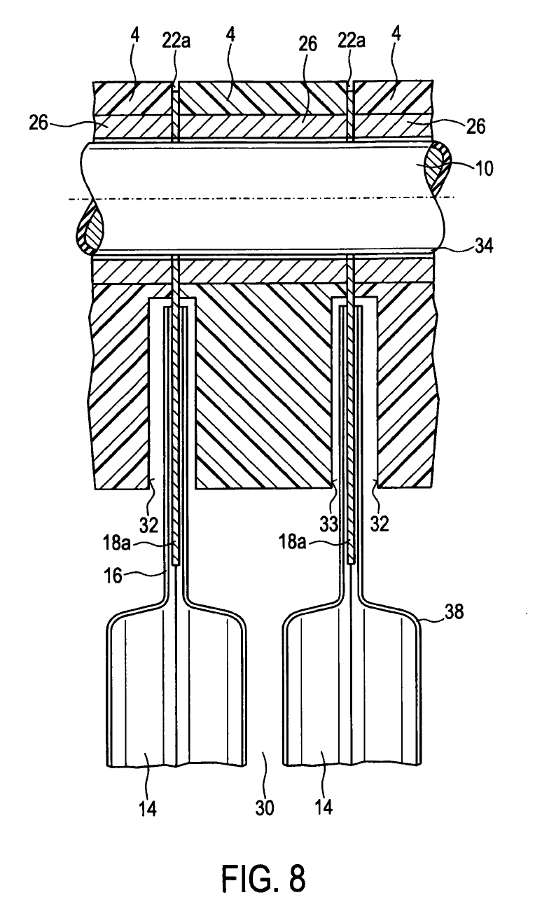

FIG. 8 an enlarged partial view of a cell block according to a third exemplary embodiment in a similar view to FIG. 4;

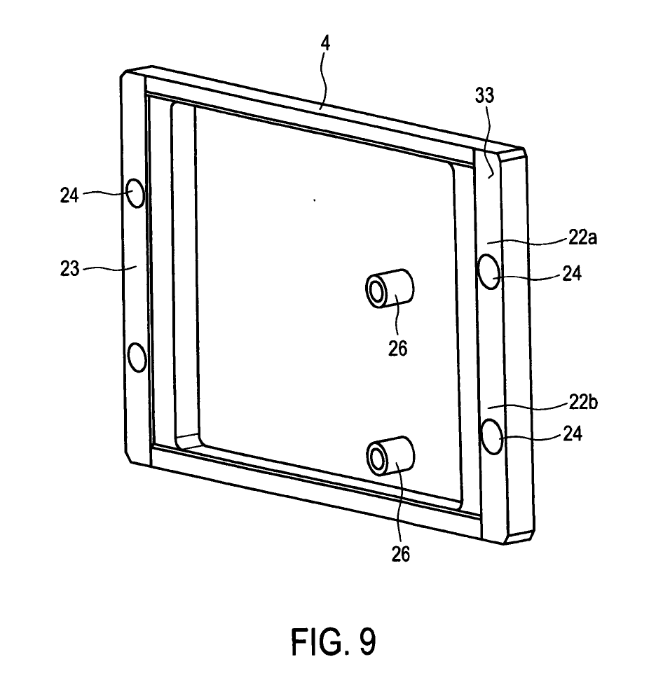

FIG. 9 a frame of the cell block of FIG. 8 with contact elements in an exploded view;

FIG. 10 a schematic plan view of a narrow side of the cell block of FIG. 8 to illustrate the parallel connection of the storage cells; and

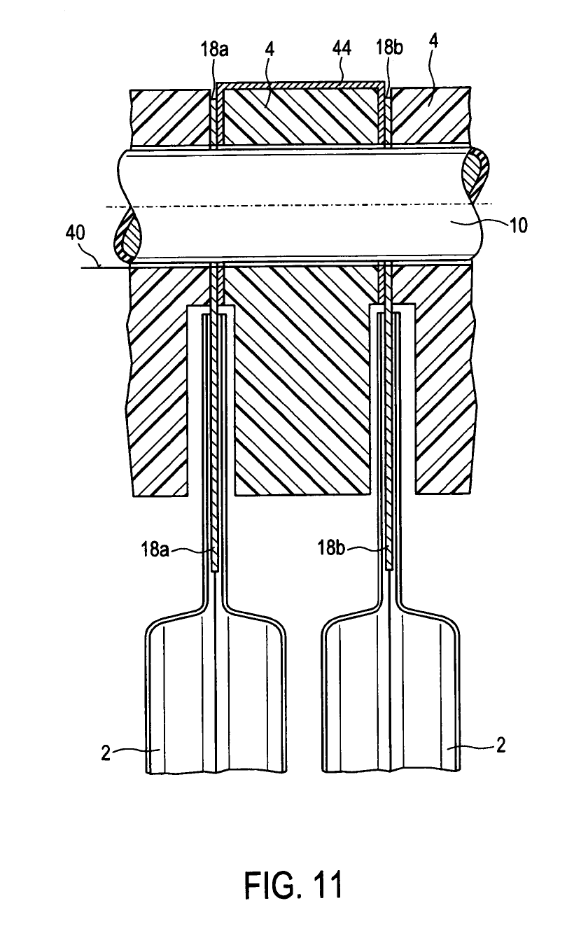

FIG. 11 an enlarged partial view of a cell block according to a fourth exemplary embodiment in a view corresponding to FIG. 4.

A first exemplary embodiment of the present invention is now described with reference to FIGS. 1 to 6. In this case, FIG. 1 is a perspective view of a cell block 1 of the present invention in the assembled state; FIG. 2 is a perspective exploded view of the cell block 1 according to the first exemplary embodiment in a partially assembled state; FIG. 3 is a partial plan view of the cell block 1 as a horizontal longitudinal section on a plane “III” in FIG. 1; FIG. 4 is an enlarged view of a detail “IV” in FIG. 3; FIG. 5 shows a spacing element from FIG. 2 with a contact element in an exploded view; and FIG. 6 shows a partial plan view of a narrow side of the cell block in FIG. 2.

According to the overall perspective view in FIG. 1, a cell block 1 comprises a plurality of storage cells 2 (galvanic cells, accumulator cells or the like, only one being visible in FIG. 1), a plurality of intermediate frames 4 acting as spacing elements, two end frames 6, two pressure rings 8 and four tie rods 10 with nuts 12 mounted on both sides as a clamping means. One of the two end frames 6, the intermediate frame 4 and the second of the two end frames 6 form a stack which is held together via the pressure rings 8 disposed at the end by means of the tie rods 10 and nuts 12. The storage cells 2 are located within the structure created by the stacked frames 4, 6.

The cell block 1 from FIG. 1 is shown in FIG. 2 as a perspective partial exploded view. In other words, the nuts 12 are removed and on the side facing the onlooker the pressure ring 8, the end frame 6, a storage cell 2 and an intermediate frame 4 are detached from the tie rods 10.

According to the representation in FIG. 2, the storage cells 2 are configured as so-called flat cells or pouch cells, each having a first current conductor 18a and a second current conductor 18b disposed on one narrow side. With this embodiment, the consecutive storage cells 2 in the stack are rotated relative to one another, so that a second current conductor 18b follows a first current conductor 18a in the stack direction in each case and vice versa. In this way, a series connection of the storage cells 2 can be formed, as illustrated in FIG. 6.

Furthermore, each storage cell 2 has an active part 14, a sealing seam (an edge area) 16 and the two current conductors 18a, 18b. The electrochemical reactions for the storage and delivery of electrical energy take place in the active part 14. Any kind of electrochemical reaction may be used in principle to construct the storage cells; however, the description relates particularly to lithium-ion accumulator batteries, to which the invention is particularly applicable, due to the requirements in terms of mechanical stability and heat management and the economic significance.

The active part 14 is encased like a sandwich between two films, wherein the overlapping edges of the films are bonded together in a gas and liquid-tight manner, forming the so-called sealing seam 16. As shown in FIGS. 2 and 3, a positive first current conductor 18a and a negative second current conductor 18b project from one narrow side of the storage cell 2. At least one bore 20 (hereinafter referred to as a terminal bore) is present in each of the current conductors 18a, 18b.

The storage cells 2 are threaded with the pole bores 20 onto the tie rods 10, namely such that one storage cell 2 in each case is either disposed between two intermediate frames 4 or between an intermediate frame 4 and an end frame 6. The frames 4, 6 are constructed such that the active part 14 of the storage cells 2 is disposed in the cavity of the frame 4, 6, while first and second pressure surfaces 22a, 22b press against the flat sides of the current conductors 18a, 18b and hold them secure following the tightening of the tie rods 10 and nuts 12. Third pressure surfaces 23 of the frames 4, 6 preferably accommodate a part of the sealing seam 16 of the storage cells 2 between them, so that the ends of the storage cells 2 facing away from the current conductors 18a, 18b are positioned at a distance in the cell block 1. The sides of the frames 4, 6 are also referred to as pressure bars.

The frames 4, 6 further comprise bores 24 disposed in their pressure surfaces 22a, 22b, 23, in which, in part, sleeve-shaped contact elements 26, 27 are accommodated. To be more accurate, contact elements 26 are disposed in the intermediate frames 4 and contact elements 27 are disposed in the end frames 6, which differ from one another only in terms of their lengths (in the stack direction), as the intermediate frames 4 are thicker than the end frames 6. The bores 24 and the contact elements 26, 27 are aligned with the terminal bores 20 in the current conductors 18a, 18b of the storage cells 2. The frames 4, 6 with their bores 24 and contact elements 26, 27 are therefore also threaded via the tie rods 10.

As can be seen particularly in FIGS. 4 to 6, only one contact element 26 is held in a bore 24 in each intermediate frame 4, namely either in the region of the first pressure surfaces 22a or in the region of the second pressure surfaces 22b. Moreover, the contact elements 26 are arranged alternately in the intermediate frames 4, i.e. where there are two consecutive intermediate frames 4 in the stack, in a first intermediate frame 4 the contact element 26 in the bore 24 is provided in the region of the first pressure surfaces 22a, while in a second intermediate frame 4, the contact element 26 in the bore 24 is provided in the region of the second pressure surfaces 22b.

The contact elements 26 here in the case of an intermediate frame 4 represent an electrical contact between the current conductors 18a, 18b bearing against the respective pressure surfaces 22a, 22b of the storage cells 2 arranged on both sides, while in the case of an end frame 6 the contact sleeves 27 make an electrical contact between a positive or negative current conductor 18a, 18b of a storage cell 2 and one of the pressure rings 8. In the region of the other pressure surface 22b, 22a in each case, in which no contact elements are disposed, the frame 4, 6 forms electrical insulation between the current conductors 18b, 18a of two storage cells 2 between or the current conductor 18b, 18a and the pressure ring 8.

By means of the alternately rotated storage cells 2 and the alternating configuration of the contact elements 26 in the bores 24 of the intermediate frame 4, all storage cells 2 in the cell block 1 are connected to one another “positive to negative”, i.e. a series connection of the storage cells 2 is realized in the cell block 1. Moreover, the current conductor 18a, 18b of the first and last storage cell 2 in the cell block 1, which is not connected to another storage cell 2, is connected via the contact element 27 in the respective end frame 6 to the pressure ring 8 in each case, so that said pressure rings 8 form a positive and a negative terminal, to which the pole voltage of the entire cell block 1 is applied.

As described above, the frames 4, 6 are made of an inexpensive, electrically insulating material such as plastic, for example, which is solid or fibre-reinforced. On the other hand, the contact elements 26, 27 are made of an electrical conductor such as copper or brass, bronze or another copper alloy or another metal or another metal alloy, with or without a conductivity-improving coating of silver or gold, for example.

The contact elements 26, 27 are supported on the rear side of the current conductors 18a, 18b by the material of the frame 4, 6. Insofar as the material of the frame 4, 6 is more yielding than the material of the contact elements 26, 27, provision must be made on both lateral sides by means of suitable measures to ensure that the yield of the frame 4, 6 on the side without a contact element (insulating side) is the same as the total yield of the frame material and the sleeve material on the side with the contact elements 26, 27 (contacting side), in order to avoid uneven compression of the frames 4, 6. Suitable measures designed to conform the total compression or stiffness on both lateral sides of the frames 4, 6 with one another are, for example, an increased fibre content on the insulating side where a fibre-reinforced plastic is used; different material or raw material compositions on the insulating and contacting side; the use of reinforcing inserts on the insulating side and a larger bar width, at least the supporting bar width, on the insulating side. These measures may be carried out individually or in combination, in order to achieve the desired result.

In FIG. 3, which shows a horizontal longitudinal sectional view of the cell block 1 in a plane III in FIG. 1, the alternate configuration of the contact elements 26 in the intermediate frames 4 and the contact elements 27 in the end frames 6 can be recognized. Likewise, the structure of the intermediate frames 4 and of the end frames 6 can be recognized. The frames 4, 6 are configured such that the first and second pressure surfaces (22a and 22b, not depicted in greater detail in the figure) press onto the opposite flat sides of the current conductors 18a, 18b of the storage cells 2. They also exhibit a thickness, such that between the active parts 14 of the storage cells 2 an air gap 30 is formed. This air gap 30 on the one hand prevents mechanical pressure loads from reaching the active parts 14, so that disturbances in the electrochemical function which are attributable to these are avoided. On the other hand, cooling of the storage cells 2 is possible via the air gap 30.

As can be clearly seen in FIG. 3, the end frames 6 exhibit a smaller thickness than the intermediate frames 4. The fact that a storage cell 2 is only arranged on one side of the end frame 6 is thereby taken into account. Accordingly, the contact elements 27 which are arranged in the end frame 6 are also shorter than the contact elements 26 which are arranged in the intermediate frame 4.

FIG. 4 shows the contacting region between two storage cells 2 as detail IV in FIG. 3. The air gap 30 between the active parts 14 of the storage cells 2 can also be clearly seen. By means of cut outs 32, 33 in the pressure surfaces 22a or 22b of the intermediate frames 4, it is guaranteed that the pressure surfaces 22a, 22b only exert pressure on the respective current conductors 18a, 18b, but not on the other edge area of the storage cells 2 with the sealing seam 16. The cut outs 32 on the insulating side are deeper than on the contacting side. Unlike the intermediate frame 4, the end frames 6 only have cut outs 32, 33 on one flat side.

The tie rod 10 supports a continuous sleeve 34 made of an insulating material; in addition, between the tie rod 10 and the components penetrated by said tie rod, a distance 36 is provided. In this way, the tie rod 10 is electrically insulated against the conductive or non-potential-free parts, in other words, the current conductors 18a, 18b, the pressure rings 8 and the contact sleeves 26, 27, and a short-circuit is effectively avoided. Although not depicted in greater detail in the figure, the frames 4, 6, the pressure rings 8 and the storage cells 2 are held radially centred, such that the distance 36 between the tie rods 10 and the conducting or non-potential-free parts 18a, 18b, 26, 27, 8 is constantly maintained; suitable means of centring are, for example, aligning pins or a geometrically correspondingly aligned moulding of the stacked components. Likewise not depicted in greater detail in the figures, provision is also made for suitable insulation of the nuts 12 in respect of the pressure rings 8; this may be achieved by means of insulating plates or collar bushings, for example, the cylinder part of which projects into the respective pressure ring 8.

In relation to the structure of the storage cells 2, it is evident from FIG. 4 that the current conductors 18a, 18b on the positive and negative side exhibit different thicknesses. The films 38 for encasing the active parts 14 of the storage cells 2 can also be seen here.

An intermediate frame 4 is shown individually in FIG. 5 in a perspective representation with the first pressure surfaces 22a, the second pressure surfaces 22b, the third pressure surfaces 23, the bores 24 and the cut out 33. In this case, a sleeve-shaped contact element 26 is inserted into a bore 24 in the intermediate frame 4, which is arranged in the region of the second pressure surfaces 22b.

FIG. 6 once again illustrates the sequence of the first and second current conductors 18a, 18b of the storage cells 2 and the correspondingly alternating configuration of the contact elements 26 to achieve series connection of the storage cells 2 of the cell block 1.

A second exemplary embodiment of the present invention is now described by reference to FIG. 7. In this case, the view in FIG. 7 corresponds to that in FIG. 5 of the first exemplary embodiment.

As shown in FIG. 7, sleeve-shaped contact elements 26 made of an electrically conductive material and sleeve-shaped supporting elements 42 made of an electrically insulating material are accommodated in the intermediate frame 4 of the cell block 1. In this case, a contact element 26 in the bore 24 is disposed in the region of the one pressure surface 22b of the intermediate frame 4 and a supporting element 42 in the bore 24 is arranged in the region of the other pressure surfaces 22a of the intermediate frame 4. In this case, the positions of the contact elements 26 and the supporting elements 42 are selected alternately in the consecutive intermediate frames 4 in the cell block 1, in order to realize the series connection of the storage cells 2 illustrated above in connection with the first exemplary embodiment. The end frames 6 of the cell block 1 in this exemplary embodiment have correspondingly additional supporting sleeves arranged on the side of the insulating pressure surfaces in addition to the contact sleeves 27.

The supporting elements 42 are made of a material which exhibits a yield or strength corresponding to that of the contact elements 26, 27. The contact sleeves 26, 27, which bear against the current conductors 18a, 18b of the storage cells 2, can therefore be effectively supported by the supporting sleeves which bear against the rear side of the current conductors 18a, 18b. A one-sided compression of the frames 4, 6 is therefore avoided in just the same way as a caving-in of the contact sleeves 26, 27 and deformation of the current conductors 18a, 18b as a result of this.

The supporting sleeves 42 may optionally exhibit a greater outer diameter than the contact sleeves 26, in order to provide a particularly effective supporting effect. The supporting sleeves 26 are made of a hard, electrically insulating material such as a glass or ceramic material, for example, or a hard, possibly fibre-reinforced, plastic. The above embodiments apply accordingly to the supporting sleeves, which are arranged in the end frames 6.

Otherwise, the cell block in this exemplary embodiment corresponds substantially to that of the first exemplary embodiment described above.

A third exemplary embodiment of the present invention is now described with reference to FIGS. 8 to 10. In this case, the views in FIGS. 8 to 10 correspond to those in FIGS. 4 to 6 in the first exemplary embodiment.

The storage cells 2 of the cell block 1 are connected in parallel in this exemplary embodiment. For this purpose, contact elements 26 are disposed in the bores 24 in the intermediate frames between all first and second pressure surfaces 22a, 22b of the intermediate frames 4 acting as spacing elements. Moreover, all storage cells 2 of the cell block 1 are arranged in the same way, so that the first current conductors 18a of all storage cells 2 are arranged behind one another and alongside these the second current conductors 18b of all storage cells 2 are arranged behind one another.

Moreover, the cell block in this third exemplary embodiment corresponds substantially to that in the first exemplary embodiment described above.

A fourth exemplary embodiment of the present invention is now described with reference to FIG. 11. In this case, the view in FIG. 11 corresponds to that in FIG. 4 in the first exemplary embodiment.

FIG. 11 shows the contacting region between a first current conductor 18a of a storage cell 2 and a second current conductor 18b of an adjacent storage cell 2.

According to the representation in FIG. 11, a contact spring 44 is provided in the contacting region of the intermediate frame 4, said contact spring creating a contact between the current conductors 18a, 18b of the two adjacent storage cells 2. The contact spring 44 is made from a good conductor material (see above) and has a U-shaped profile. The contact spring 44 is mounted from the outside on the first or second pressure surfaces 22a, 22b of the intermediate frame 4. The intermediate frame 4 exhibits a smaller thickness at this point than in the remaining region, and the internal width of the U-profile of the contact spring 44 corresponds to the thickness of the intermediate frame 4 at this point. The outer width of the U-profile of the contact spring 44 corresponds to the thickness of the intermediate frame 4 outside the pressure surfaces 22a or 22b to be brought into contact. The contact spring 44 exhibits bores in its protruding sides, which are aligned with the bores 24 in the pressure surfaces 22a and 22b of the intermediate frame 4 and exhibit the same diameter.

The above explanations likewise apply to the end frames, which are not represented in greater detail for this exemplary embodiment. In this case, contact springs with a smaller width corresponding to the smaller thickness of the end frame must be used.

The contact springs 44 do not offer any significant resistance to the pressure applied by the tie rods, so that no asymmetrical compressions occur in the contacting and insulating regions of the intermediate frames 4. The contact springs 44 extend over the entire height of the pressure bar of the frames, so that an indentation of the pressure surfaces 22a, 22b cannot be expected either.

In a modification, the contact springs 44 are provided with an insulating cover on the exposed lateral area or an insulating cover is provided there.

Otherwise, the cell block of this fourth exemplary embodiment substantially corresponds to that of the first exemplary embodiment described above. In addition, the cell block of the fourth exemplary embodiment may also be combined with the insulating support elements 42 of the second exemplary embodiment.

In addition to the exemplary embodiments described above, further variants of the invention are conceivable for the person skilled in the art.

Hence, in a modification, instead of the end frames and intermediate frames described above, bar-shaped spacing elements (spacing or assembly bars) are used, which together form the frame described above. The spacing bars comprise bores and contact elements as described above, and are threaded onto the tie rods like the frames on a lateral side of the cell block alternating with the current conductors of the storage cells. Since the tie rods are determined by the pressure rings in terms of their radial position, following clamping via the pressure rings, a rigid and stable block is formed, which is lighter than a cell block with frame, due to the lower material usage. If necessary, the pressure rings will be thicker than in the case of the exemplary embodiments described earlier or they will exhibit reinforcements. Instead of sleeves or contact springs, the spacing bars may be entirely composed either of a conductor material or of an electrically insulating material, wherein the material chosen for the insulating spacing bar is one which exhibits a pressure yielding capacity equal to that of the conductor material.

In a further modification, spacing bars as described above are held in corresponding recesses in the frames 4, 6.

In a further modification, two or more tie rods are used for each current conductor.

### REFERENCE LIST

1 Cell block
2 Storage cell
4 Spacing element, intermediate frame
6 End frame
8 Pressure ring
10 Tie rod
12 Nut
14 Active part of 2
16 Sealing seam of 2
18a First current conductor of 2
18b Second current conductor of 2
20 Terminal bore in 18a or 18b
22a First pressure surface of 4, 6
22b Second pressure surface of 4, 6
23 Third pressure surface of 4, 6
24 Bore in 4, 6
26, 27 Contact element, contact sleeve
28 Bore in 8
30 Air gap
32, 33 Cut out in 4, 6
34 Coating or sleeve of 10
36 Distance
38 Cover film of 2
40 Bore in 4
42 Supporting sleeve
44 Contact spring

1. An electrochemical energy storage device comprising:
a plurality of flat storage cells, each having a first current conductor and a second current conductor on a same narrow side of the storage cell;
a plurality of spacing elements, each being arranged between two storage cells to maintain a predetermined distance between the storage cells; and
a clamping means for clamping the storage cells and spacing elements together to form a stack,
wherein the spacing elements each have on their two sides facing a storage cell, in a region of the narrow side of the storage cell on which the two current conductors are disposed, a first pressure surface and a second pressure surface,
wherein the first current conductor of the storage cells in each case is clamped between the first pressure surfaces of two spacing elements by a force provided by the clamping means, and the second current conductor of the storage cells in each case is clamped between the second pressure surfaces of two spacing elements a force provided by the clamping means,
wherein in at least one of a region of the first pressure surfaces or in a region of the second pressure surfaces of a spacing element in each case, a contact element is provided to make an electrically conductive connection between the first or second pressure surfaces of the spacing element, and
wherein at least one of the spacing elements or the contact elements are designed in such a way that compressions between the first pressure surfaces and between the second pressure surfaces conform to one another.

2. The energy storage device according to claim 1, wherein
the spacing elements each have a third pressure surface on their two sides facing a storage cell, in a region of a narrow side, on which the first and second current conductors of the storage cell are not disposed; and
at least one of the spacing elements or the contact elements are configured in such a way that the compressions between the first pressure surfaces, the second pressure surfaces and the third pressure surfaces conform to one another.

3. The energy storage device according to claim 1, wherein
the storage cells are stacked behind one another, such that the first current conductors and the second current conductors of the storage cells are each arranged alternately behind one another; and
in the region of the first pressure surfaces of a spacing element in each case, a contact element is provided to make an electrically conductive connection between the first pressure surfaces of the spacing element, and in the region of the other pressure surfaces of the spacing element, in each case an insulating structure is provided to form electrical insulation between the other pressure surfaces of the spacing element.

4. The energy storage device according to claim 1, wherein
the storage cells are stacked behind one another, such that the first current conductors of all storage cells are arranged behind one another and the second current conductors of all storage cells are arranged behind one another; and
in a region of the first pressure surfaces and in the region of the second pressure surfaces of the spacing element in each case, a contact element is provided to make an electrically conductive connection between the first or second pressure surfaces of the spacing element.

5. The energy storage device according to claim 1, wherein
the clamping means comprises a plurality of tie rods extending through bores in the first or second current conductors.

6. The energy storage device according to claim 1, wherein
the contact elements are made of an electrically conductive material and accommodated in the spacing elements.

7. The energy storage device according to claim 3, wherein
the insulating structures each include at least one supporting element made of an electrically insulating material, and which is accommodated in the spacing element.

8. The energy storage device according to claim 1, wherein
at least one of the contact elements or the supporting elements are configured as a sleeve and accommodated in corresponding recesses in the spacing elements; and
the clamping means extends through the contact or supporting elements that are configured as sleeves.

9. The energy storage device according to claim 1, wherein
the spacing elements are each configured as a substantially four-sided frame.
